(19) United States
(12) Patent Application Publication
(10) Pub. No.: US 2008/0192951 A1
(43) Pub. Date: Aug. 14, 2008

(54) SPECTATOR BROADCAST SYSTEM WITH AN EAR MOUNTED RECEIVER

(76) Inventor: Edward Moura, Victoria (CA)

Correspondence Address: J. GORDON THOMSON, P.O. BOX 8865, VICTORIA, BC, V8V 3Z1, omitted

(21) Appl. No.: 11/672,635

(22) Filed: Feb. 8, 2007

(51) Int. Cl. H04H 40/18

(52) U.S. Cl. 381/80

(57) ABSTRACT

A spectator broadcast system includes a transmitter for broadcasting over one or more broadcast channels and a light weight ear mounted receiver for selectively receiving one or more broadcast channels. The receiver comprises a radio circuit, a speaker, control means comprising an on/off function and volume control, a power source, a channel selector switch and a semi-transparent case adapted to mount comfortably over the ear of a wearer by means of an ear hanging member. A light source is included to illuminate the case. In another embodiment spread spectrum technology is used. The system is adapted to broadcast over distances and at power levels permitted by the authorities.

This invention relates to a telecommunication device comprising of a transmitter broadcasting at a low power signal to a crowd of spectators within an open or closed forum who receive the broadcast on a small ear mounted receiver.

### BACKGROUND

### Description of Known Art

Spectators at sporting events such as baseball games in an open or closed stadium are often seen carrying radios in order to listen to the commentary as they watch the game. In large stadiums commentators are located in a broadcasting booth advantageously placed within the stadium so that they can view the movement of the players and describe the game to listeners. The commentary is broadcast over radio stations to listeners within range of the station. Within the forum where the game is being played the spectator must tune into a local radio station that is broadcasting the same game live. This method has a number of disadvantages: the physical structure of the forum may block radio signals; the local game may be blacked out, that is, local stations may be prohibited from broadcasting game commentary; the spectator must carry a radio to the event; ambient noise in the stadium may make listening to the radio commentary difficult; the radio may necessitate the use of ear plugs or headphones which can be a nuisance, a tripping hazard and uncomfortable in hot summer weather; the radio broadcast may have commercials that may disrupt the commentary; and, the radio broadcast may disturb other spectators.

To overcome some of these disadvantages there has been an attempt to develop a spectator broadcasting system using small portable radios. One example of the known art is U.S. Pat. No. 5,513,384 “System and method for providing multiple broadcasts of audio information to spectators” issued to Brennan et al on Apr. 30, 1996. Brennan et al describes a system that includes an FM radio transmitter to broadcast the commentary to radio receivers held by spectators to listen to the commentary. While Brennan et al offers a system and method to broadcast commentary to a large group of spectators within an open or closed forum, it still has the following disadvantages: it broadcasts within frequency ranges that must have regulatory approval to operate; the radio receiver is too large, too heavy and too cumbersome for comfortable use and must be attached to the listener's belt; the radio uses an ear plug connected by a length of wire to the radio receiver which is uncomfortable, poses a tripping hazard and is prone to dislocation from movement of the spectator.

Therefore there exists disadvantages and shortcomings in the known art of spectator broadcast systems which the present invention seeks to overcome.

### SUMMARY

In accordance with one embodiment of the present invention there is provided a spectator broadcast system with an ear mounted receiver comprising a small light-weight transmitter adapted for radiating energy in an omni-directional pattern. The radiated energy is one of radio, ultrasound, spread spectrum technology signals or inductive signals. Also included is an ear mounted and cordless receiver for receiving the radiated energy. The transmitter and ear mounted receiver are generally within one kilometer of each other. The transmitter may be analog or digital and broadcasts generally within the range of 200 MHz to 1 GHz at a low power level which complies with existing government regulations. The ear mounted receiver contains an antenna adapted to receive the low power signals from the transmitter, a circuit to convert the radio signals to electrical signals and audio output, a speaker and a power source. The ear mounted receiver also contains control features to control the on-off function, volume and broadcast channel selection.

The ear mounted receiver of our invention is very light weight and adapted to fit comfortably over the ear of a wearer for the duration of a spectator event. A soft pliable cushion is used over the speaker to create a comfortable long-wearing fit for the wearer. No intrusive ear plug is used and the listening activity is private. There are no cords associated with the ear mounted receiver and so there is no tripping or entanglement hazard associated with its use.

In another embodiment of the invention the distance between the transmitter and receiver is up to two kilometers.

In yet another embodiment of the invention the transmitter and ear mounted receiver broadcast and receive on a single channel.

In still another embodiment of the invention the transmitter and ear mounted receiver broadcast and receive on more than one channel.

In one embodiment of the invention, the transmitter and ear mounted receiver operate in a digital format.

In another embodiment of the invention the transmitter and ear mounted receiver operate in an analog format.

In yet another embodiment of the invention, the ear mounted receiver case is molded from transparent or semi-transparent recycled plastic and/or bio-degradable plastic material and therefore is ecologically advantageous.

The invention is operated by a low voltage long-life battery. In one embodiment of the invention the battery is replaceable and/or rechargeable and has a life of up to 60 hours.

In another embodiment of the invention the battery is not replaceable and has a life of 6 to 8 hours.

### OBJECTS AND ADVANTAGES

Accordingly, besides the objects and advantages of our spectator broadcast system with ear mounted receiver described above, several objects and advantages of our invention are: providing a spectator broadcast system that complies with existing government regulations; providing a spectator broadcast system that does not interfere with or receive commercial TV, AM or FM broadcasts; providing an ear mounted radio receiver that is lightweight and fits comfortably over the ear of the wearer negating cumbersome wires, cords and belt clamps; providing a base for advertising or team loyalty displays on the surface of the radio ear mounted receiver; providing for multiple business models for the commercialization and use of the invention, namely, a multiple long-term use ear mounted receiver unit wherein the battery is replaceable and a single short-term use ear mounted receiver wherein the battery is not replaceable; and,

providing ecological advantages through the use of recycled materials and/or bio-degradable materials to construct the casing of the invention.

Another advantage of our invention is that the ear mounted receiver operates virtually hands-free and is not dislodged by spectator movement. Still another advantage is that the transmitters can broadcast commentary in different languages at the same time and the ear mounted receiver can receive the commentary in multiple languages on different channels and the wearer is able to switch between channels using a single button on the ear mounted receiver.

Still further objects and advantages of our invention will become apparent from a consideration of the following diagrams and detailed description.

### DESCRIPTION OF THE DRAWING FIGURES

FIG. 1 is a view of the spectator broadcast system of one embodiment of our invention comprising a transmitter and ear mounted receiver with its casing shown in ghost lines.

FIG. 2 is a front view of the ear mounted receiver of one embodiment of our invention.

FIG. 3 is a right-side view of the ear mounted receiver of one embodiment of our invention in ghost lines showing positioning of the major internal components.

FIG. 4 is a right side view of the ear mounted receiver of one embodiment of our invention.

FIG. 5 is a left side view of the ear mounted receiver of one embodiment of our invention.

FIG. 6 is a back side view of one embodiment of the ear mounted receiver of one embodiment of our invention.

FIG. 7 is a side-of-head view of one embodiment of the ear mounted receiver of our invention mounted to the ear of a wearer.

FIG. 8 is a back-of-head view of one embodiment of the ear mounted receiver mounted to the ear of a wearer.

FIG. 9 is a front-of-head view of one embodiment of the ear mounted receiver mounted to the ear of the wearer.

### DETAILED DESCRIPTION

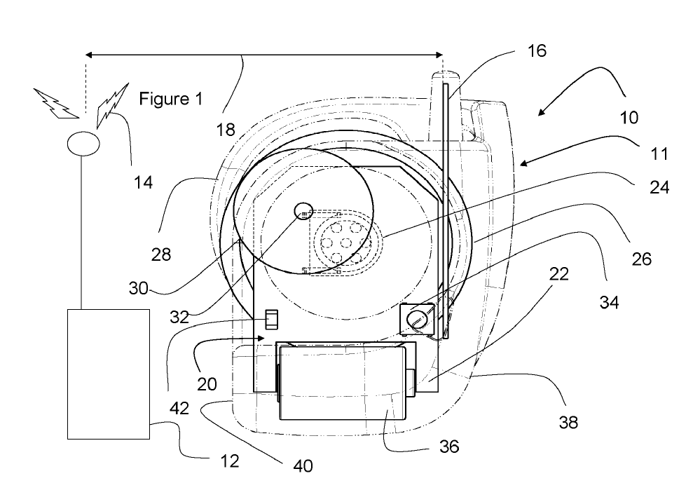

Referring now to FIG. 1, there is a schematic of our invention which is a radio broadcast system (10) comprising a transmitter (12) adapted for radiating energy (14) in the radio frequency portion of the electromagnetic spectrum in an omni-directional pattern. The transmitter weighs between 1 and 2 kilograms depending on the power of the transmitter. Hence it is very compact and portable. The system further comprises an ear mounted receiver (shown with transparent lines) (11) comprising an antenna (16) for receiving the energy (14) radiated from the transmitter (12). The antenna and receiver are located within a distance (18) from the transmitter (12). Transmitter to receiver distance (18) can be up to one kilometer. However, depending on the power output of the transmitter (12) the distance (18) can be up to two kilometers. The components of the ear mounted radio receiver are shown generally as (20) and are mounted on printed circuit board (22). The ear mounted receiver is adapted to convert the radio signals received by antenna (16) to an electrical signal and audio output. The audio output is transmitted to a speaker (24) which converts the audio output into an audible sound. As more fully explained below, the speaker is placed adjacent to the ear of the wearer and is covered by a comfortable ear cushion (26). The ear mounted receiver is adapted to hang from either the left ear or the right ear of the wearer by member (28) which can be configured for left or right ear wear. Although the figures herein may depict the ear mounted receiver hanging from one particular ear it is to be understood that it can be made to hang from either ear. The invention is ideally suited for broadcasting commentary about a sporting event such as a baseball game to a large crowd of spectators in a stadium. The invention can be used in open stadium or in closed forum such as hockey arenas. As well, the invention is well suited for broadcasting to tour groups on a bus or moving through museums or historic sites.

FIG. 1 illustrates control means comprising a rotating disc (30) or thumb wheel that combines the on/off switch and volume control. The volume control is mounted on the printed circuit board or the case. In the latter mounting, the volume control is electrically connected to the printed circuit board. The disc (30) is mounted to the circuit board (22) by way of axis (32).

Where the ear mounted receiver is capable of receiving more than one channel comprising discrete frequency bandwidths the channel selection switch (34) permits the user to move between channels by a push button operation. For example, to change the language of the commentary that is broadcast in different languages simultaneously over different channels the wearer would need only to push a single control button.

The power source (36) is enclosed within case (38) and is adapted for powering the ear mounted receiver and the speaker. In one embodiment the battery has a life of up to 60 hours. It may be rechargeable as well. The battery is replaceable through battery hatch (40). In another embodiment of the invention the battery is not replaceable by the user and has a life of only between 6 to 8 hours. This latter embodiment would be suitable for single event applications. The battery is preferably a lithium battery but other types having different shapes and compositions can be used.

To avoid the complications and cost associated with compliance with regulations promulgated by radio spectrum managers such as the United States Federal Communications Commission (FCC) and Industry Canada, the radio frequency transmitter (12) transmits generally at a frequency of between 200 MHz and 1 GHz. This is an area of the radio spectrum containing various frequencies which do not require licensing depending on the broadcast power levels. Therefore no regulatory approval is required to operate our invention within power levels specified by the authorities. The transmitter (12) is generally analog and broadcasts in a frequency modulation (FM) mode. A digital transmitter can also be used. One mode of transmission in one embodiment of our invention uses spread spectrum technology which employs frequency hopping wherein a signal is spread over a broader area of available bandwidth. For example, the FCC allows the use of spread spectrum technology in three radio bands, 902-928 MHz, 2.400-2.4835 GHz and 5.7525-5.850 GHz for transmission under 1 Watt of power. No FCC site license is required for this type of transmission. These three radio bands can be further subdivided into a plurality of channels. Spread spectrum technology has the advantages of reducing interference, noise and eavesdropping. It is also well suited to low power transmissions as in our invention. Spread spectrum technology has been adapted to wireless computer local area networks and digital cellular phones and so a person skilled in the art of this technology would be aware of its application and suitability to our invention. Its advantage is that it permits a large number of users to broadcast over the same set of frequencies. Further discussion of spread spectrum modulation is not necessary as this technique is well described in various sources such as IEEE 802.11 Wireless LAN Standard.

Still referring to FIG. 1, the ear mounted receiver includes a light source (42) that is adapted to illuminate when the on/off switch is turned on and the unit is operating. The light source can be a LED or some other suitable light source. The light source also acts as the power source management means and indicates the state of the battery and will not illuminate when the battery has insufficient charge to operate the ear mounted receiver.

The case (38) is made from a suitable semi-transparent thermoplastic to permit viewing of the interior structure of the ear mounted receiver (11). The case may be offered in a variety of colors. The light source (42) can be mounted to the board (22) and is bright enough to illuminate the case providing a pleasing and interesting visual effect when the ear mounted receiver is operating. For example, electronic circuitry can be adapted to cause the light source to fluctuate in the realms of audible sound in the ear mounted receiver thereby creating a stadium-wide visual effect.

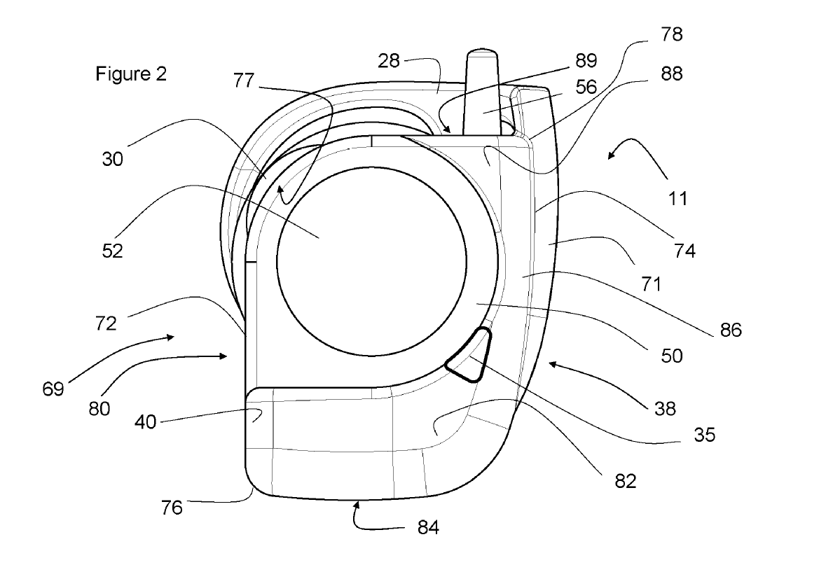

Referring now to FIG. 2 there is shown a front view of the ear mounted receiver (11) of one embodiment of our invention. The case (38) is about two inches wide and about two and one half inches long. The width of the case varies from about one half inch at the top of the case to one inch at the bottom of the case. The case is manufactured using molding techniques from a suitable thermoplastic material that can be derived from recycled materials. Hence, the case is extremely light and easily suspended from the ear of the wearer by the ear hanging member (28). Control dial (30) protrudes from the case (38) so that it can be easily manipulated by finger or thumb sliding movements. Antenna cap (56) is illustrated as is a button (35) over channel selection switch (34—FIG. 1). The wearer pushes the button in order to cycle through the available channels until the desired channel is found. Since the wearer is only receiving radio signals there is no danger with respect to radiating energy at such close proximity to the human body. The internal antenna is connected to a suitable circuit adapted to receive and amplify low power signals from the transmitter. The construction of the ear mounted receiver circuitry is well known in the case of FM modulation and therefore a person skilled in the art would be able to construct a radio receiver small enough to fit within the case. Further discussion of the components of the radio receiver populating the circuit board is not necessary. The case (38) of the ear mounted receiver comprises a first lozenge-shaped body (69), a second body (71) adjacent to the first body and ear hanging member (28). The first body comprises a concave and arcuate side (72) on the left side of the case and a second opposite convex and arcuate side (74) on the right side of the case. The sides are joined at points forming rounded corners (76) and (78). The first body is adapted to encase the control board containing the components of the ear mounted receiver. Control disc (30) protrudes from the apex (77) of the curve of the arcuate side (72). Within the lozenge-shaped front surface area defined between the joined sides (72) and (74) is a tear-shaped flat portion (80) which comprises flat circular area (52) used to mount graphics such as advertisement or team logos and a surrounding tear-shaped flat area (50). In another embodiment of the invention, area (52) may be slightly raised above surface (50) to provide a prominent position for advertisement. Adjacent to the tear-shaped area (80) is a second raised area (82) that is curved around the right side and bottom of the tear-shaped area (80) and semi-surrounds it. The raised area (82) comprises a bulbous bottom and horizontally aligned portion (84) that is adapted to house the battery and includes battery hatch (40) and upright portion (86) that mounts the frequency control switch (35) and includes a top portion (88) curving to the left of the case and having a flat top surface (89) that mounts antenna cap (56).

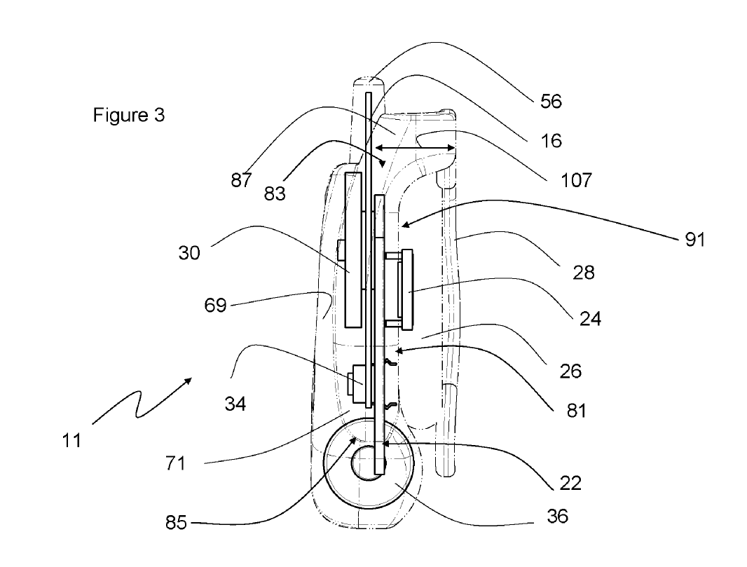

Referring now to FIG. 3 and with continued reference to FIGS. 1 and 2, there is shown a transparent view of the left side of ear mounted receiver (11). Various components and their placement are illustrated, including: control disc (30), antenna (16), antenna cap (56), speaker (24), speaker cushion (26), circuit board (22), channel switch (34) and battery (36). The placement of the ear hanging member (28) in relation to the speaker (24) and speaker cushion (26) is also shown. The casing (38—FIG. 2) is shown to comprise a first body (69) and second body (71) illustrated in ghost lines. Second body (71) has a first vertical portion (81) having a top (83) and a bottom (85) and a second horizontal portion (87) projecting rearward a predetermined distance (107) from the top (83) of the first vertical portion (81). The second horizontal portion (87) is adapted to support the ear hanging member (28). Distance (107) is sufficient to permit placement of the cushion (26) between the back (91) of the case (38—FIG. 2) and the ear hanging member without compression of the cushion.

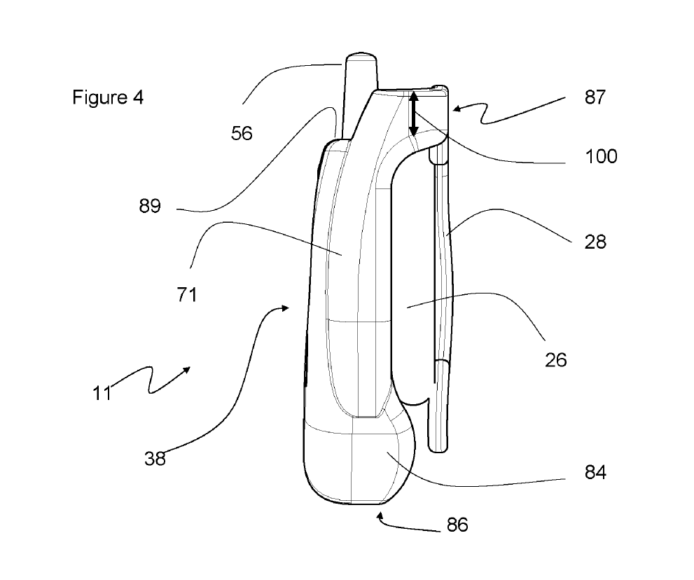

Referring to FIG. 4 there is shown a solid line left side view of one embodiment of the ear mounted ear mounted receiver (11). Portion (84) is shown having a generally bulbous shape adapted to house the battery. In the embodiment where the battery is replaceable the battery hatch (40) (see FIG. 2) is on the right side of portion (84). The case (38) has a bottom surface (86) that is parallel to top surface (89). Top surface (89) mounts the antenna cap (56). As seen in this view, the second body (71) has a vertical orientation and an elongate curved shape. The second body (71) projects over the top surface (89) of the first body (69—FIG. 3) a predetermined distance (100) and extends rearward a distance (107—FIG. 3). Ear hanging member (28) is suspended from the horizontal top portion (87) of the second body (71) such that the cushion (26) is disposed between the back of the case and the ear hanging member.

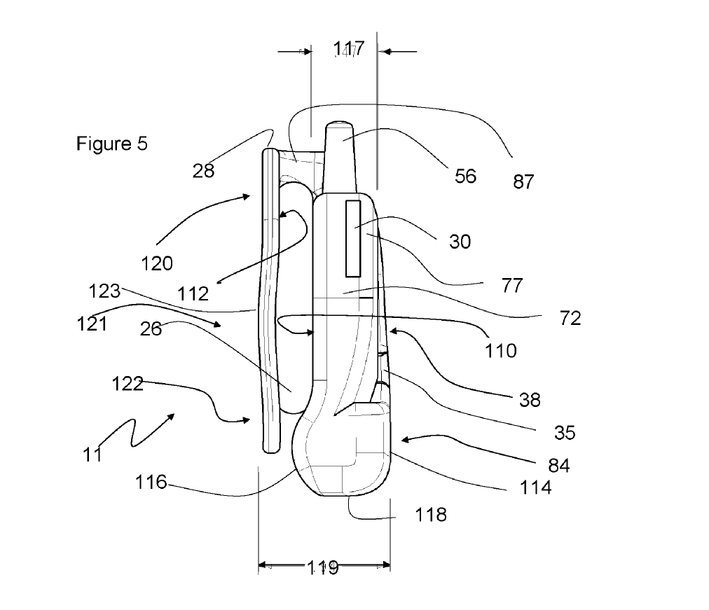

Referring now to FIG. 5, with continued reference to FIGS. 1 to 4, there is shown a right side view of the ear mounted receiver (11) illustrating the ear hanging member (28) fixed to the horizontal portion (87) of second body (71—FIG. 4). The ear cushion (26) is placed over speaker (24—FIG. 3) and is disposed between the back side (110) of the case (38) and the inside surface (112) of the ear hanging member (28). Channel selection button (35) is disposed on the second area (82—FIG. 2) of first body (69—FIG. 3). Bulbous portion (84) is shown having a front surface (114) that is generally vertical and a back surface (116) that has a concave arcuate shape rising from a flat bottom surface (118). In this embodiment the shape of second portion (84) is adapted to receive a circular battery. In other embodiments, the battery may be rectangular thereby obviating the need for the bulbous profile of second portion (84). Also illustrated in FIG. 5 are antenna cap (56) and control dial (30) rising from the apex (77) of side (72).

Still referring to FIG. 5, there is shown ear hanging member (28) having a top section (120) and a bottom section (122) in vertical alignment. Between the top section and the bottom section is a middle section (121) that is not in vertical alignment with the top and bottom sections and has a bowed shape wherein the bow (123) is directed towards the rear of the ear mounted receiver. The receiver (11) casing (38) has a bottom width (119) which is about one inch and a top width (117) which is about one-half inch.

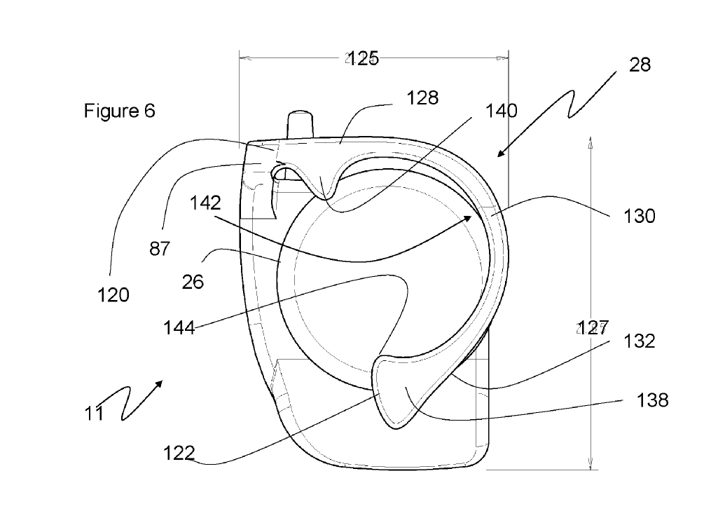

Referring to FIG. 6, there is illustrated a back view of the ear mounted receiver (11) with the ear hanging member (28) having a first end (120) that is integral to the horizontal portion (87) of the second body (71—FIG. 4). This integral joint at (120) permits a limited amount of flexibility of the ear hanging member so that the ear mounted receiver can be easily mounted onto an ear and that the biased ear hanging member gently holds the ear mounted receiver in place. In another embodiment of the invention the ear hanging member is pinned to the horizontal portion (87) and permits in a biased pivot the desired amount of flexibility of the ear hanging member while gently urging the ear hanging member against the ear of the wearer. The outside peripheral surface of the ear hanging member has a generally flat top surface (128) that extends from the joint at (120) to the commencement of a curved surface (130) that in turn terminates in a generally linear section (132). The bottom (122) of the ear hanging member includes a flared portion (138) that is adapted for placement behind the ear lobe of the wearer to maintain the receiver in place upon the ear of the wearer. The inside curved peripheral surface (142) of the ear hanging device includes a first cusp (140) that is adapted to fit in front of the top surface of the wearer's ear. The inside curved surface (142) is adapted to curve about the back surface of the wearer's ear and terminates in a second cusp (144). The resilient joint at (120), the first cusp (140) and the second cusp (144) act in cooperation to engage the surface of the ear so as to maintain the ear mounted receiver over the ear of the wearer in a comfortable and secure manner. Cushion (26) is compressed against the ear of the wearer by the biasing action of the joint at (120) to permit the wearer to hear commentary without a large amount of interference from ambient noise. Generally, the receiver (11) has a top width of about 2 inches (125) and a height of about 2.6 inches (127) although these dimensions may vary.

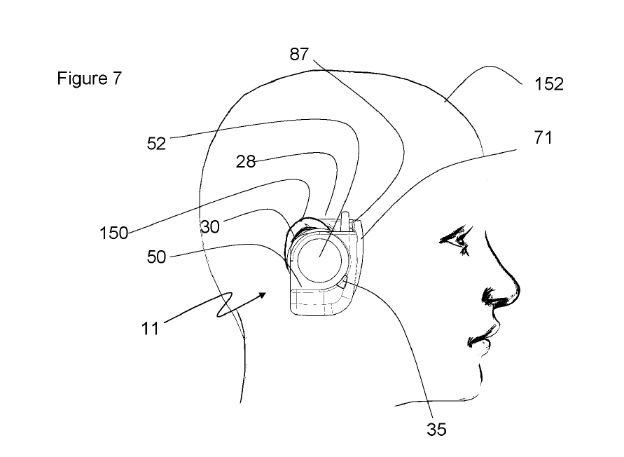

Referring now to FIG. 7 there is shown a side-of-head view of the ear mounted receiver (11) hanging from the ear (150) of a wearer's head (152). The ear mounted receiver retains balance and perpendicularity on the ear of the wearer. The ear hanging member (28) is illustrated extending from the horizontal portion (87) of the second body (71) behind ear of the wearer. On/off switch and volume control dial (30) and channel selection button (35) are within easy reach of the wearer's hands. The ear mounted receiver is very light in weight and does not put any uncomfortable downward pressure on the ear of the wearer. Additionally, there are no wires hanging down from the ear mounted receiver that would lead to discomfort and possible accidental entanglement. Area (52) and area (50) are clearly visible to adjacent individuals who will be able to view the team logo, advertisement and the activity of the internal light source. The ear mounted receiver is also well adapted to those persons wearing glasses and does not interfere with the arm of the glasses and does not cause irritation to persons wearing glasses.

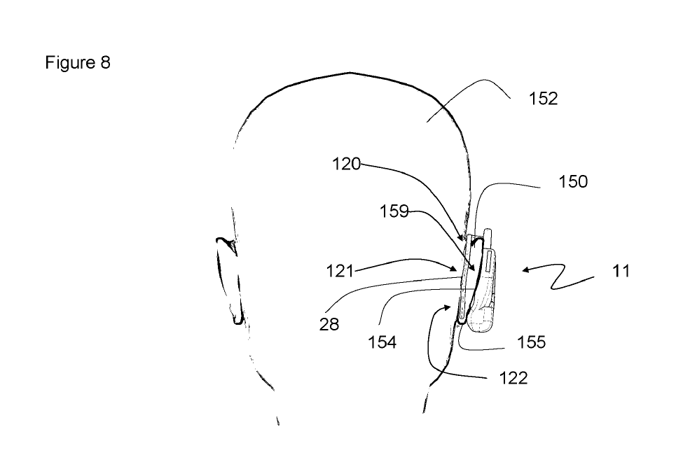

Referring now to FIGS. 6 and 8 there is shown a back-of-head view of the ear mounted receiver (11) hanging from the ear (150) of the wearer's head (152). The ear mounted receiver (11) is canted slightly towards the wearer at an angle that is generally the same angle as the outer surface (154) of the ear. The ear hanging member (28) is shown reaching around the back of the ear and extending downwards to a point behind the lobe of the ear (155). The ear hanging member (28) is shown in this illustration to be generally perpendicular but it would obviously conform to the angle of the side of the wearer's head for maximum comfort. Between the top portion (120) and bottom portion (122) of the ear hanging member (28) is bowed middle portion (121). Bowed portion (121) is in gentle frictional contact with the side of the wearer's head behind the ear to provide a frictional surface against which movement of the ear hanging member is resisted. This helps keep the ear mounted receiver stable on the ear of the wearer. Additionally the bowed portion (121) of the ear hanging member (28) ensures that the adjacent top (120) and bottom (122) portions of the ear hanging member push gently against the back surface (159) of the ear to press it into the ear cushion (26) of the ear mounted receiver. Additional frictional contact between the upper and lower portions of the ear hanging member with the back surface of the ear further ensures stable mounting of the ear mounted receiver on the ear of the wearer.

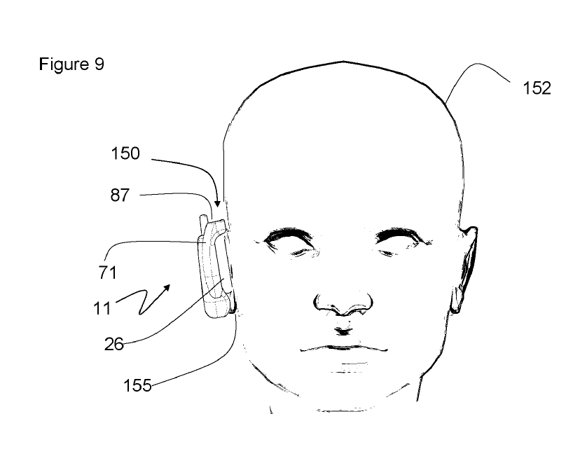

Referring now to FIGS. 6 and 9 there is shown a front-of-head view of ear mounted receiver (11) mounted on the ear (150) of the wearer's head (152). The ear mounted receiver (11) is canted slightly towards the head of the wearer and conforms to the angle of the wearer's outer ear. Second body (71) horizontal portion (87) is shown proximate to the top of the ear. The ear hanging member (28-—FIG. 6) extends downwards from the horizontal portion (87) and curves around the back of the ear. The flared portion (138—FIG. 6) of the bottom of the ear hanging member is adapted to sit behind the ear lobe (155) of the wearer. In this view the cushion (26) over the speaker is pressed comfortably against the ear of the wearer by the biasing action of the ear hanging member.

Although the description above contains much specificity, these should not be construed as limiting the scope of the invention but as merely providing illustrations of some of the embodiments of this invention. Thus the scope of the invention should be determined by the appended claims and their legal equivalents.

What is claimed is:

1. A spectator broadcast system with an ear mounted receiver comprising:
a. a transmitter adapted for radiating energy in an omni-directional pattern over one or more broadcast channels simultaneously;
b. an ear mounted receiver adapted for receiving said energy over said one or more channels simultaneously and converting the energy into audible sounds, said ear mounted receiver comprising:
i. an electrical circuit for converting the received energy into electrical signals and audio output;
ii. a speaker for converting said electrical signals into said audible sound;
iii. control means comprising an on/off function and volume control;
iv. means for selecting between the one or more broadcast channels;
v. a power source for driving said circuit and said speaker; and,
vi. a case adapted to mount comfortably over the ear of a wearer for the duration of a spectator event wherein said case is further adapted to contain said electrical circuit, said speaker, said control means and said power source.

2. The system as claimed in claim 1 wherein the energy takes the form of one of radio energy, ultrasound energy, infra-red light energy or inductive energy.

3. The system as claimed in claim 2 wherein the energy is radio energy transmitted in a frequency modulation mode and wherein the electrical circuit is a radio circuit adapted to receive frequency modulated radio energy and convert them into audible sounds.

4. The system as claimed in claim 3 wherein the electrical circuit, the control means, the selecting means, the speaker and the power source are mounted to a printed circuit board.

5. The system as claimed in claim 4 wherein the ear mounted receiver further includes a light source mounted to said printed circuit board, and wherein said light source has a first illuminated mode when the ear mounted receiver is on and a second non-illuminated mode when the ear mounted receiver is off.

6. The system as claimed in claim 5 wherein the case is manufactured from ecologically advantageous and semi-transparent thermoplastic material, and further wherein the light source has sufficient brightness to illuminate the case.

7. The system as claimed in claim 6 wherein said means for selecting between the one or more broadcast channels is a single push button mounted to the printed circuit board.

8. The system as claimed in claim 7 wherein the transmitter and the ear mounted receiver are separated by a distance of up to one kilometer.

9. The system as claimed in claim 7 wherein the transmitter and the ear mounted receiver are separated by a distance of more than one kilometer.

10. The system as claimed in claim 1 wherein the transmitter broadcasts at a power level specified by the regulatory authorities so that the transmitter does not require a broadcast license.

11. The system as claimed in claim 10 wherein the transmitter transmits generally at a frequency of between 200 MHz and 1 GHz.

12. The system as claimed in claim 11 wherein the control means comprises a rotating disc mounted to the circuit board, and further wherein said rotating disc is adapted to control the on/off function and volume control of the ear mounted receiver.

13. The system as claimed in claim 12 wherein the power source is one of a group of power sources comprising: a replaceable non-rechargeable battery, a replaceable rechargeable battery, a non-replaceable non-rechargeable battery and a non-replaceable rechargeable battery, and wherein the power source has a life of up to 60 hours.

14. The system as claimed in claim 12 wherein the power source is a non-replaceable non-rechargeable battery having a life between 6 hours and 8 hours, and further wherein said non-replaceable battery non-rechargeable battery is sealed within the case.

15. A spectator broadcast system with an ear mounted receiver comprising:
a. a frequency modulation transmitter adapted for radiating radio energy in an omni-directional pattern over one or more broadcast channels simultaneously, wherein said transmitter transmits generally at a frequency of between 200 MHz and 1 GHz;
b. an ear mounted receiver adapted for receiving said radio energy over said one or more broadcast channels and converting the radio energy into audible sounds, wherein said ear mounted receiver and the transmitter are separated by a distance of up to one kilometer, and wherein the ear mounted receiver comprises:
i. an electrical circuit for converting the radio energy into electrical signals;
ii. a speaker for converting said electrical signals into said audible sounds;
iii. an on/off function switch adapted for volume control;
iv. a battery for driving said circuit and said speaker;
v. a channel selection switch comprising a single button so that the wearer can switch between the one or more broadcast channels;
vi. a light source for indicating that the ear mounted receiver is on and operating;
vii. a circuit board for mounting said electrical circuit, the speaker, said on/off switch, said light source, said channel selection switch and said battery; and,
viii. an ecologically advantageous and semi-transparent thermoplastic case adapted to mount comfortably over the ear of a wearer for the duration of a spectator event wherein said case is adapted to contain said circuit board, and further wherein the light source has sufficient brightness to illuminate said case.

16. The system as claimed in claim 15 wherein the distance between the transmitter and ear mounted receiver is more than one kilometer.

17. The system as claimed in claim 16 wherein the case is manufactured from recycled semi-transparent thermoplastic material.

18. The system as claimed in claim 17 wherein the case comprises a left side, a right side, a top, a bottom, a front, a back, a first body adapted to house said circuit board; a second body adjacent to and integral with said first body, an ear hanging member fixed to said second body for hanging the case from the ear of a wearer and, a cushion disposed over the speaker and between the back of the case and said ear hanging member.

19. The system as claimed in claim 18 wherein the first body comprises a left arcuate side having a convex shape and a right arcuate side having a concave shape, wherein the said left arcuate side and said right arcuate side join to form a lozenge-shaped front surface having rounded corners.

20. The system as claimed in claim 19 wherein said front surface comprises a tear-shaped flat portion comprising a first flat circular area and a second flat tear-shaped area surrounding said first flat circular area, wherein the first flat circular area is adapted to mount graphics.

21. The system as claimed in claim 20 wherein said first flat circular area is raised above the second flat-tear shaped area to more prominently display said graphics.

22. The system as claimed in claim 21 wherein the front surface further comprises a raised area semi-surrounding said tear-shaped flat portion, wherein said raised area comprises a bottom bulbous horizontal section that is adapted to contain the battery and an upright section that is adapted to mount the second body.

23. The system as claimed in claim 22 wherein the second body is mounted to the first body on the right side of the case, and further wherein the second body comprises a first vertical portion having a top and a bottom and mounted to the first body and a second horizontal portion projecting rearward a predetermined distance from the top of the first vertical portion, wherein said second horizontal portion is adapted to support said ear hanging member, and wherein said predetermined distance is sufficient to permit placement of said cushion between the back of the case and the ear hanging member without compression of the cushion.

24. The system as claimed in claim 23 wherein the ear hanging member comprises a first end flexibly fixed to the second horizontal portion and a second free end.

25. The system as claimed in claim 24 wherein the ear hanging member first end is integral to the second horizontal portion, and further wherein there is permitted a limited amount of flexibility about the ear hanging member first end to accommodate placement of the ear mounted receiver over the ear of the wearer.

26. The system as claimed in claim 25 wherein the first end of the ear hanging member is pinned to the second horizontal portion so that there is permitted a limited amount of biased rotation about the first end of the ear hanging member.

27. The system as claimed in claim 25 where, in profile, the ear hanging member has a top section and a bottom section in vertical alignment and a middle section slightly bowed away from the back of the case in order to permit comfortable placement of the ear mounted receiver on the ear of the wearer.

28. The system as claimed in claim 27 wherein said middle section is further adapted to push the ear of the wearer towards the cushion in order to maintain a close fit between the wear of the wearer and the cushion.

29. The system as claimed in claim 28 wherein the first end of the ear hanging member further comprises a cusp depending there from, said cusp adapted to engage the ear of the wearer in order to maintain the ear mounted receiver on the ear.
